(19) United States
(12) Patent Application Publication
(10) Pub. No.: US 2011/0014032 A1
(43) Pub. Date: Jan. 20, 2011

(54) VANE GRILLE ARRANGEMENT OF AN EXHAUST GAS TURBOCHARGER, EXHAUST GAS TURBOCHARGER, AND METHOD FOR PRODUCING A VANE GRILLE ARRANGEMENT

(75) Inventors: Ralf Boening, Reiffelbach (DE); Dirk Frankenstein, Worms (DE); Holger Faeth, Fussgoenheim (DE); Marc Hiller, Morschheim (DE)

Correspondence Address: LERNER GREENBERG STEMER LLP, P O BOX 2480, HOLLYWOOD, FL, 33022-2480, US

(73) Assignee: CONTINENTAL AUTOMOTIVE GMBH, Hannover (DE)

(21) Appl. No.: 12/922,894

(22) PCT Filed: Mar. 11, 2009
(86) PCT No.: PCT/EP2009/052821

§ 371 Date: Sep. 16, 2010

(30) Foreign Application Priority Data
Mar. 18, 2008 (DE) 10 2008 014 680.3

(51) Int. Cl. F04D 29/56; B23P 15/00

(52) U.S. Cl. 415/148; 29/888.02

(57) ABSTRACT

A vane grille arrangement of an exhaust gas turbocharger with variable turbine geometry, contains at least one carrier ring formed from at least one sheet metal part and used to mount VTG guide vanes, the VTG guide vanes being rotatably mounted in recesses of the carrier ring. Ideally, an exhaust gas turbocharger has such a variable turbine geometry.

The present invention relates to a vane grille arrangement of an exhaust gas turbocharger with variable turbine geometry.

The present invention further relates to an exhaust gas turbocharger with variable turbine geometry and a method for producing such a vane grille arrangement for or in an exhaust gas turbocharger.

Exhaust gas turbochargers with variable turbine geometry (VTG) have proved in the past to be advantageous for increasing performance and for reducing the fuel consumption of internal combustion engines. By means of the variable turbine geometry, the inlet cross section, by which the hot exhaust gases are conducted onto the turbine wheel of the exhaust gas turbocharger, may be varied. By this measure, in contrast with an exhaust gas turbocharger with fixed, non-adjustable turbine geometry, the speed of the boost pressure build-up may be adjusted depending on the engine speed and the engine load. Thus, in an exhaust gas turbocharger with variable turbine geometry, a rapid boost pressure build-up may be ensured at each engine operating point. The drawbacks of an exhaust gas turbocharger with fixed turbine geometry during boost pressure build-up, such as for example severely delayed boost pressure build-up at low engine speeds which is denoted, for example, as “turbo lag”, may be effectively prevented or at least reduced by means of an exhaust gas turbocharger with variable turbine geometry.

In conventional exhaust gas turbochargers with VTG, the variable turbine geometry is implemented by an adjustable vane grille. Such a vane grille consists of a ring of guide vanes of variable alignment, which is arranged in a narrow region denoted as the vane chamber between the exhaust gas supply channel of the turbine and the turbine rotor.

In order to permit effective, low-loss control of the exhaust gas flow, the vane chamber should not be configured substantially broader than the height of the guide vanes. On the other hand, however, the vane chamber should also not be dimensioned too narrowly, as then the guide vanes could jam during operation as a result of the thermal deformation of components.

The publication EP 1 734 231 A1 discloses a turbocharger with variable turbine geometry, in which the adjustable vane grille, as disclosed above, is formed by a ring of guide vanes of variable alignment. In this case, the adjustability of the guide vanes is implemented by the rotatable mounting of the guide vanes in a carrier ring, which is also denoted as a vane bearing ring.

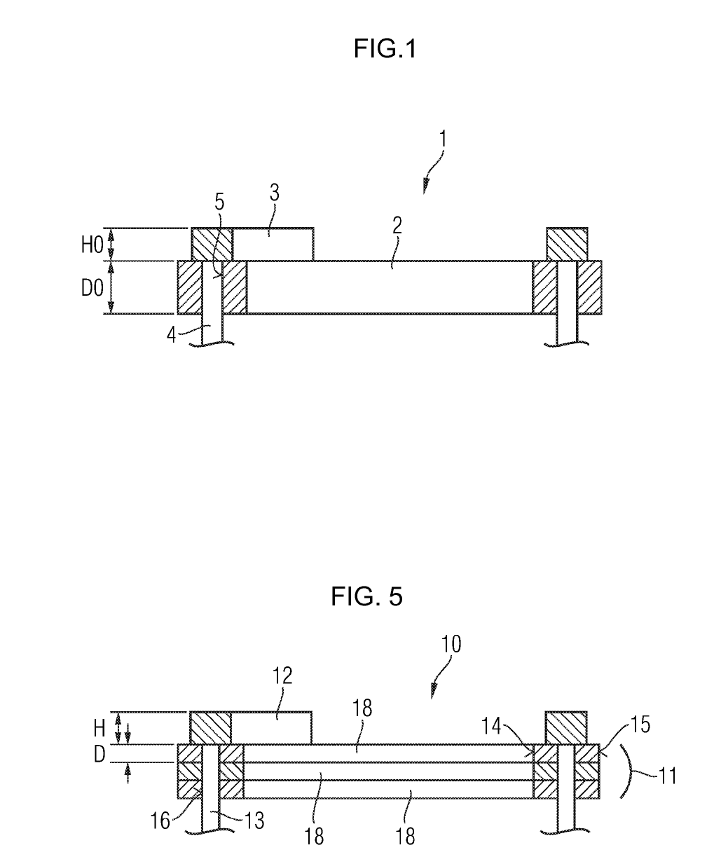

FIG. 1 shows a known vane grille arrangement 1 as is disclosed, for example, in the publication EP 734 231 A1. The vane grille arrangement 1 consists of a vane bearing ring 2, in which a plurality of VTG guide vanes 3 are mounted. The VTG guide vanes 3 are rotatably mounted in recesses 5 of the vane bearing ring 2 by means of integrally formed pivot pins 4. The vane bearing ring 2 has a thickness D0 which is one to two times the height H0 of the VTG guide vanes 3.

Such a vane bearing ring is typically produced by means of machining production methods. For the machined production of a vane bearing ring, turning processes, drilling processes and possibly also milling processes are required. In order to produce the vane bearing ring by means of machining production methods, machine tools specifically provided therefor have to be provided which makes the production of such vane bearing rings complex and cost-intensive.

In the publication EP 1 394 364 B1, a vane bearing ring with a similar construction to the vane bearing ring shown in FIG. 1 is disclosed. In this case, the production of a vane bearing ring by means of a casting method is proposed. During production of the vane bearing ring as a cast part, the construction of the prototype and mold, the provision of a suitable smelting furnace and the post-machining required with a cast part may be cited as major cost factors. Even the production of a vane bearing ring as a cast part is, as a result, associated with a considerable cost.

Given this background, it is an object of the present invention to provide an alternative vane grille arrangement for mounting the VTG guide vanes of an exhaust gas turbocharger which is cost-effective relative to conventional solutions. Moreover, it is a further object of the present invention to provide an exhaust gas turbocharger with such a vane grille arrangement as well as a method for producing such a vane grille arrangement.

According to the invention, at least one of these objects is achieved by a vane grille arrangement having the features of claim 1 and/or by a vane grille arrangement having the features of claim 3 and/or by an exhaust gas turbocharger having the features of claim 12 and/or by a method for producing a vane grille arrangement having the features of claim 13.

Accordingly, a vane grille arrangement of an exhaust gas turbocharger is provided with variable turbine geometry, which comprises at least one carrier ring formed from at least one sheet metal part and used to mount the VTG guide vanes, the VTG guide vanes being rotatably mounted in recesses of a carrier ring.

Moreover, a vane grille arrangement of an exhaust gas turbocharger with variable turbine geometry is provided which comprises at least one carrier ring which is formed from at least one annular component and which comprises VTG guide vanes, which are rotatably mounted in recesses of a carrier ring, the annular component(s) in each case having an axial extension which is less than 75% of the height of the VTG guide vanes.

Moreover, according to the invention an exhaust gas turbocharger is provided which comprises a portion on the turbine side with a supply channel for supplying exhaust gas, in which a turbine rotor is rotatably mounted and in which a vane grille arrangement is provided according to the invention.

Moreover, a method for producing a vane grille arrangement according to the invention is provided with the following method steps: providing at least one sheet metal part, producing a carrier ring with recesses from the at least one sheet metal part, provision of VTG guide vanes, and inserting the VTG guide vanes into the recesses of a carrier ring.

The idea underlying the present invention is to provide a vane grille arrangement comprising at least one carrier ring formed from at least one conventional sheet metal part for the rotatable mounting of the VTG guide vanes, which is designed to be thin in comparison with conventional carrier rings. By the use of carrier rings produced from sheet metal and configured to be thin compared with conventional solutions, rapid and uniform through-heating of the carrier rings is ensured during operation. As a result, the risk of jamming of the VTG guide vanes in the vane chamber as a result of thermally induced deformation of the carrier ring is markedly reduced. Moreover, when using such carrier rings, material savings may be made in comparison with conventional carrier rings of thicker design. These savings of costly, high temperature-resistant material permit a production of the vane grille arrangement which is cost-effective compared to known solutions.

A further idea of the present invention is to provide an exhaust gas turbocharger with variable turbine geometry comprising a vane grille arrangement according to the invention.

By fitting a vane grille arrangement according to the invention into an exhaust gas turbocharger, the total production costs for an exhaust gas turbocharger may be reduced compared to conventional exhaust gas turbochargers. As the risk of jamming of the VTG guide vanes is reduced by using a vane grille arrangement according to the invention, an exhaust gas turbocharger with such a vane grille arrangement is characterized by a higher operational reliability compared to conventional exhaust gas turbochargers.

A further idea of the present invention is to provide a method for producing a vane grille arrangement according to the invention. Relative to conventional methods for producing a vane grille arrangement, the method according to the invention is characterized in that the carrier rings for mounting the VTG guide vanes are produced from conventional sheet metal parts. As a result, during production of the carrier rings, material savings may be achieved in comparison with machined production or production as a cast part. As a result of these savings of costly, high temperature-resistant material, the method according to the invention permits a cost-effective production of a vane grille arrangement according to the invention compared to conventional methods.

Advantageous embodiments and developments of the invention form the subject-matter of the sub-claims as well as the description with reference to the drawings.

According to a preferred embodiment of the invention, the sheet metal parts used for producing the carrier rings have a thickness which is less than 75% of the height of the VTG guide vanes. More preferably, the thickness of the sheet metal parts is less than 60% and, further preferably, less than 50% of the height of the VTG guide vanes. Such an embodiment of the carrier rings has the advantage that with a reduced thickness of the sheet metal parts used for producing the carrier rings, a more rapid and more uniform through-heating of the carrier rings is ensured, and the risk of jamming of the VTG guide vanes in the vane chamber as a result of thermally induced deformation of the carrier rings, is increasingly reduced. Moreover, with a reduced thickness of the sheet metal parts used for producing the carrier rings, increased material savings may be made during the production of the carrier rings. In turn, reduced production costs for the entire vane grille arrangement result therefrom.

A vane grille arrangement is provided in a typical embodiment of the invention, the VTG guide vanes thereof in each case comprising a vane part and a pivot pin integrally formed thereon. By such a structural design of the VTG guide vanes, said VTG guide vanes may be rotatably mounted in a simple manner in the respective recesses of a carrier ring.

In a further preferred embodiment of the invention, a vane grille arrangement is provided in which the sheet metal parts are stamped and/or nibbled out for producing the carrier rings and the recesses of the carrier rings. As a result, cost advantages result during the production of the carrier rings and during the production of the entire vane grille arrangement. Alternatively, the sheet metal parts for producing the carrier rings and the recesses of the carrier rings naturally may be also produced by means of one or more further cost-effective methods, such as for example by a further shearing method, a wedge-action cutting method (in this case, in particular, by a dual blade cutting method) or by a cleavage method.

In a first, general embodiment of the invention a vane grille arrangement is provided comprising a single carrier ring, the pivot pins of the guide vanes being rotatably mounted in the recesses thereof. By such a one-sided mounting of the VTG guide vanes, a particularly simple and cost-effective construction of the vane grille arrangement is permitted.

In a further preferred embodiment of the invention, a vane grille arrangement is provided with at least two, and in particular just two, carrier rings, between which the VTG guide vanes are sandwiched and in the recesses thereof the pivot pins of the VTG guide vanes are rotatably mounted. Such a double-sided bearing of the VTG guide vanes has the advantage that in spite of the carrier rings which are of very slim design, a large span is provided for absorbing forces on the VTG guide vanes.

In a further preferred embodiment of the invention, a vane grille arrangement is provided in which a carrier ring is formed in each case from a plurality of sheet metal parts which are stacked on top of one another, so that the carrier ring has congruent and superimposed recesses, in which the pivot pins of the VTG guide vanes are rotatably mounted. Such a structural design of the carrier rings has the advantage that even with a single-sided mounting of the VTG guide vanes a large span is available for absorbing forces on the VTG guide vanes.

According to a typical embodiment of the invention, a vane grille arrangement is provided in which the recesses of a carrier ring are applied at the same radial distances from the central point of the carrier ring and uniformly in the circumferential direction on the carrier ring.

In a further preferred embodiment of the invention, a vane grille arrangement is provided which has an anti-twist device which in the installed state of the vane grille arrangement in the turbocharger ensures that the vane grille arrangement is fixed in the turbine housing and/or in the bearing housing of the turbocharger in a manner which is fixed in terms of rotation. Such an anti-twist device is necessary in order to support the forces applied to the VTG guide vanes on the turbine housing and/or on the bearing housing of the turbocharger. Typically, such an anti-twist device is implemented by screwing a carrier ring to the bearing housing and/or to the turbine housing. Such an anti-twist device may, however, also be configured, for example, as a tongue and groove connection between the bearing housing and/or turbine housing and the inner edge and/or outer edge of a carrier ring.

According to a particularly preferred embodiment of the invention, a vane grille arrangement is provided in which the inner edge and/or outer edge of a carrier ring is of circular configuration. Such a structural design of a carrier ring is advantageous as both the turbine rotor located inside a carrier ring and the housing parts located outside the carrier ring have circular contours. The inner edge and/or outer edge of a carrier ring may, however, naturally also be configured to be polygonal or otherwise annular—for example for producing an anti-twist device.

According to a further preferred embodiment of the invention, a method for producing a vane grille arrangement is provided in which the sheet metal parts, from which the carrier rings are produced, are produced by a shearing method. The production of the sheet metal parts by a shearing method has considerable cost advantages relative to machined production or production as a cast part. Such a shearing method may, for example, be a stamping method or nibbling method. Alternatively, the sheet metal parts for producing the carrier rings and the recesses of the carrier rings may naturally also be produced by means of one or more further cost-effective methods, such as for example by a further shearing method, by a wedge-action cutting method (in this case, in particular, by a dual blade cutting method) or by a cleavage method.

The invention is described in more detail hereinafter with reference to the exemplary embodiments provided in the schematic figures of the drawings, in which:

FIG. 1 shows a schematic sectional view of a known vane grille arrangement;

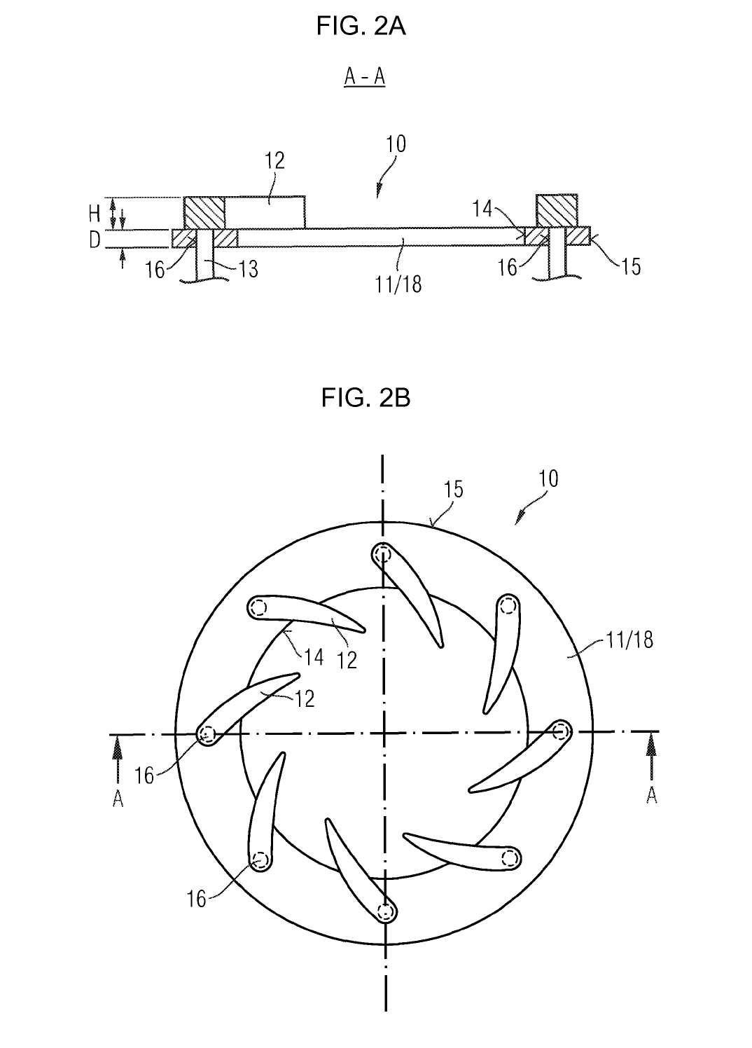

FIGS. 2A, 2B show a schematic sectional view and/or a schematic plan view of a first general embodiment of a vane grille arrangement according to the invention;

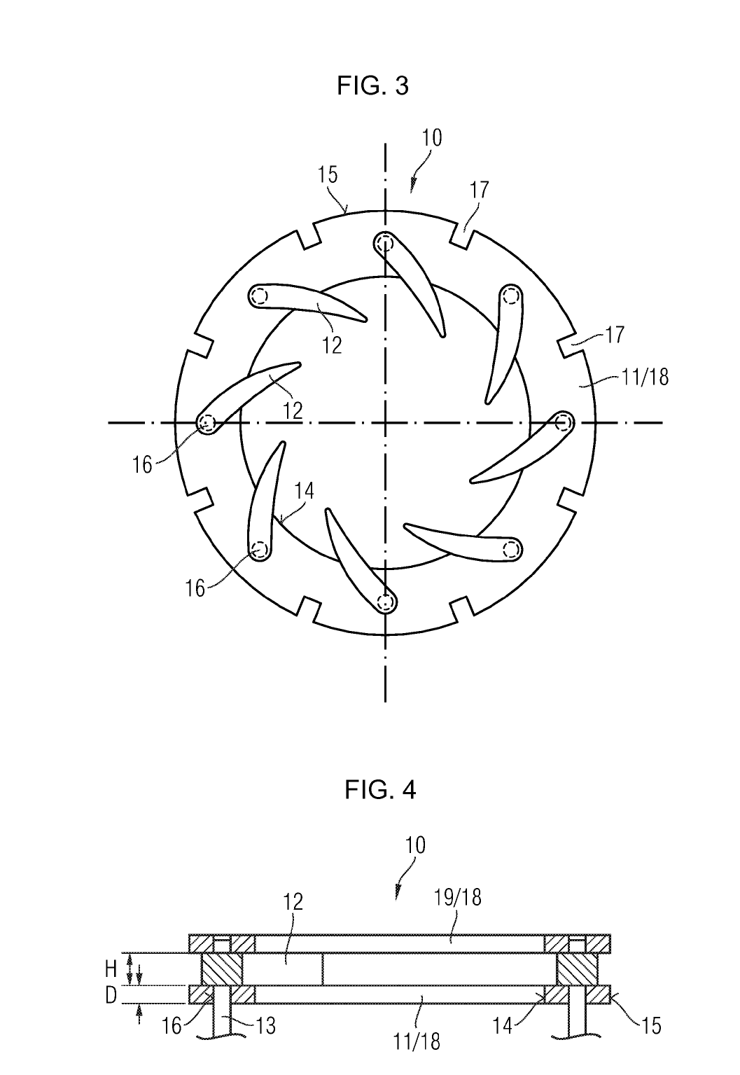

FIG. 3 shows a schematic plan view of an exemplary embodiment of a vane grille arrangement according to the invention;

FIG. 4 shows a schematic sectional view of a preferred embodiment of a vane grille arrangement according to the invention;

FIG. 5 shows a schematic sectional view of a further preferred embodiment of a vane grille arrangement according to the invention;

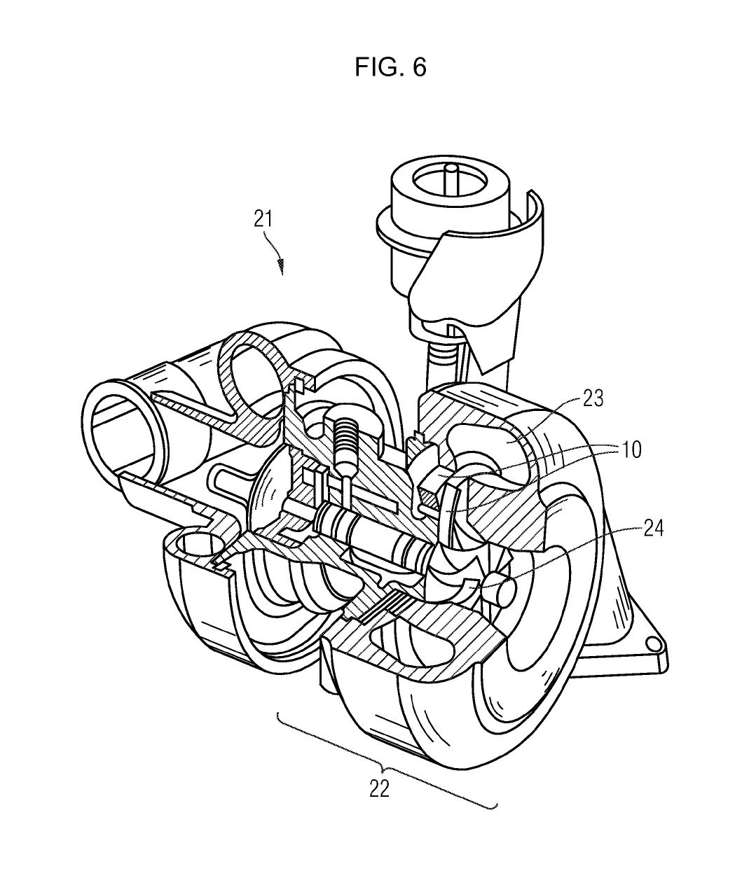

FIG. 6 shows an exemplary isometric view of an exhaust gas turbocharger with variable turbine geometry comprising a vane grille arrangement according to the invention.

In all figures of the drawings, elements which are the same and/or functionally the same—provided no variations are specified—have been provided with the same reference numerals.

FIGS. 2A and 2B show a schematic sectional view and/or a schematic plan view of a first general embodiment of a vane grille arrangement 10 according to the invention. The vane grille arrangement 10 comprises a carrier ring 11 as well as a plurality of VTG guide vanes 12, which are rotatably mounted in the carrier ring 11.

The carrier ring 11 is in this case formed from a single sheet metal part 18, and has an inner edge 14 as well as an outer edge 15. Moreover, the carrier ring 11 has a plurality of recesses 16 which, as shown by way of example in FIG. 2B, may be arranged at the same radial distances from the central point of the carrier ring 11 and uniformly in the circumferential direction on the carrier ring 11. The carrier ring 11 and thus also the sheet metal part 18 have a thickness D.

The VTG guide vanes 12 have a height H and additionally have pivot pins 13 integrally formed on the VTG guide vanes. For rotatably mounting the VTG guide vanes 12 in the vane bearing ring 11, the respective pivot pins 13 integrally formed thereon are inserted into the recesses 16 of the carrier ring 11.

According to the invention, the thickness D of the sheet metal part 18 is less than 75%, preferably less than 60% of the height H of the VTG guide vanes 12. Typically, the thickness of the sheet metal part 18 is between 3 mm and 6 mm.

By rotating the VTG guide vanes 12 mounted in the carrier ring 11, the flow cross section of the turbine may be optimally adjusted for each engine operating point. At low engine speeds or with a full engine load, the VTG guide vanes 12 are moved into a planar position in order to reduce the flow cross section of the turbine and, as a result of the more rapidly flowing exhaust gases, to permit a rapid boost pressure build-up. However, with an excess of exhaust gas on the turbine, the VTG guide vanes 12 are moved into a more inclined position in order to reduce the flow cross section of the turbine and, as a result of the exhaust gases flowing more slowly, to limit the boost pressure.

Due to the fact that the turbine of an exhaust gas turbocharger is subjected to very high exhaust gas temperatures of, for example, up to 1050° C., typically high temperature-resistant materials are used during the production of the vane grille arrangement 10 according to the invention. The vane grille arrangement 10 may thus be made, for example, from a high temperature-resistant austenitic steel with a high proportion of chromium and nickel. For increasing the strength, molybdenum, vanadium, tungsten, niobium, titanium or boron may additionally be added to the high temperature-resistant austenitic steel. Moreover, it is conceivable to produce the vane grille arrangement 10 from a nickel-based alloy or any other material which is capable of withstanding the exhaust gas temperatures prevailing inside the portion of the turbocharger on the turbine side.

FIG. 3 shows a schematic plan view of a further, exemplary embodiment of a vane grille arrangement 10 according to the invention. A carrier ring 11 is again provided, formed from a sheet metal part 18, in the recesses thereof a plurality of VTG guide vanes 12 being rotatably mounted. As shown by way of example, the carrier ring 11 has a plurality of grooves 17 attached to the outer edge 15 of the carrier ring 11, by means of which it is possible to attach the vane grille arrangement 10 in the turbine housing and/or in the bearing housing of the turbocharger in a manner which is fixed in terms of rotation.

FIG. 4 shows a schematic sectional view of a preferred embodiment of a vane grille arrangement 10 according to the invention. In addition to the first carrier ring 11 formed from a sheet metal part 18, a second carrier ring 19 formed from a sheet metal part 18 is provided therein. The VTG guide vanes 12 are sandwiched between the two carrier rings 11 and 19, so that the VTG guide vanes 12 are rotatably mounted by means of the pivot pins 13 integrally formed thereon on both sides in the recesses 16 of the carrier rings 11 and 19.

FIG. 5 shows a schematic sectional view of a further preferred embodiment of a vane grille arrangement 10 according to the invention. A single carrier ring 11 is provided therein, which is formed by three sheet metal parts 18 stacked on top of one another. The carrier ring 11 produced thereby has congruent superimposed recesses 16 in which the VTG guide vanes 12 are rotatably mounted by means of the pivot pins 13 integrally formed thereon.

FIG. 6 shows by way of example an isometric view of an exhaust gas turbocharger 21 with a vane grille arrangement 10 according to the invention. The exhaust gas turbocharger 21 has a portion 22 on the turbine side. The vane grille arrangement 10 according to the invention is in this case arranged inside the portion 22 of the exhaust gas turbocharger on the turbine side between a supply channel 23 for supplying exhaust gas and a rotatably mounted turbine rotor 24.

Although the present invention has been described above with reference to preferred exemplary embodiments, it is not restricted thereto but may be modified in various ways. Thus the invention is not restricted to the specific design of the vane grille arrangement shown in the above figures. Instead, said vane grille arrangement may be modified in any manner, without deviating from the underlying principle of the invention.

In particular, the vane grille arrangement does not necessarily have to be formed as shown in the figures, by merely one or two carrier rings, but naturally may also have three or more carrier rings. It is self-evident that a single carrier ring may not only be formed by one or three sheet metal parts but from any number of sheet metal parts stacked on top of one another, depending on which requirements are set for the carrier ring with regard to its thermomechanical behavior and its mechanical load bearing capacity.

The pivot pins of the VTG guide vanes do not necessarily have to be integrally formed on the VTG guide vanes. A single VTG guide vane may, therefore, also be formed by a separate pivot pin as well as a vane part, the two components being connected together in a suitable manner fixedly in terms of rotation. For such a connection of the pivot pins and vane part, a feather key connection, a tapered pin connection, a screw connection, a welded connection, a soldered connection or any other connection is proposed, for example, which is capable of ensuring a reliable connection of the pivot pins and vane part which is fixed in terms of rotation, at the high temperatures prevailing inside the portion of the exhaust gas turbocharger on the turbine side.

The inner edge and the outer edge of a carrier ring do not necessarily have to be of circular configuration. The inner edge and/or the outer edge of the carrier ring may instead also be configured to be polygonal or otherwise annular—for example for producing an anti-twist device.

It is obvious that the recesses for mounting the VTG guide vanes do not have to be arranged at the same distances from the central point of the carrier ring and uniformly in the circumferential direction on the carrier ring. The recesses for mounting the VTG guide vanes may instead be arranged in any manner on a carrier ring, provided that when considering the installation conditions a technically reasonable vane grille arrangement is produced in the portion of the turbocharger on the turbine side.

1-15. (canceled)

16. A vane grille configuration of an exhaust gas turbocharger having a variable turbine geometry, the vane grille configuration comprising:
VTG guide vanes; and
at least one carrier ring formed from at least one sheet metal part and having recesses formed therein, said VTG guide vanes being rotatably mounted in said recesses of said carrier ring.

17. The vane grille configuration according to claim 16, wherein said sheet metal part has a thickness which is less than 75% of a height of said VTG guide vanes.

18. The vane grille configuration according to claim 16, wherein said sheet metal part has a thickness which is less than 60% of a height of said VTG guide vanes.

19. The vane grille configuration according to claim 16, wherein said VTG guide vanes each have a vane part and at least one pivot pin formed thereon.

20. The vane grille configuration according to claim 16, wherein at least one of said sheet metal part and said recesses are one of stamped and nibbled out.

21. The vane grille configuration according to claim 16, wherein said carrier ring is a single carrier ring and said VTG guide vanes are rotatably mounted in said recesses.

22. The vane grille configuration according to claim 16, wherein said carrier ring is one of two carrier rings between which said VTG guide vanes are sandwiched and in said recesses, and said VTG guide vanes are rotatably mounted.

23. The vane grille configuration according to claim 16, wherein said carrier ring is formed from a plurality of sheet metal parts which are stacked on top of one another, and said recesses in said carrier ring are congruent and superimposed recesses in which said VTG guide vanes are rotatably mounted.

24. The vane grille configuration according to claim 16, wherein said recesses of said carrier ring are disposed at equal radial distances from a central point of said carrier ring and uniformly in a circumferential direction on said carrier ring.

25. The vane grille configuration according to claim 16, further comprising an anti-twist device which in an installed state of the vane grille configuration in the exhaust gas turbocharger with the variable turbine geometry ensures that the vane grille configuration is fixed in a portion of the exhaust gas turbocharger on a turbine side in a manner which is fixed in terms of rotation.

26. The vane grille configuration according to claim 16, wherein said carrier ring has an inner edge and an outer edge, at least one of said inner edge and said outer edge of said carrier ring is of circular configuration.

27. The vane grille configuration according to claim 16, wherein said sheet metal part has a thickness which is less than 50% of a height of said VTG guide vanes.

28. A vane grille configuration of an exhaust gas turbocharger with a variable turbine geometry, the vane grille configuration comprising:
VTG guide vanes each having a given height; and
at least one carrier ring formed from at least one annular component and having recesses formed therein, said VTG guide vanes rotatably mounted in said recesses of said carrier ring, said annular component having an axial dimension which is less than 75% of said given height of said VTG guide vanes.

29. An exhaust gas turbocharger with a variable turbine geometry, comprising:
a vane grille configuration containing VTG guide vanes and at least one carrier ring formed from at least one sheet metal part and having recesses formed therein, said VTG guide vanes being rotatably mounted in said recesses of said carrier ring;
a turbine rotor; and
a turbine side having a portion with a supply channel for supplying exhaust gas, and in which said turbine rotor is rotatably mounted and in which said vane grille configuration is disposed.

30. A method for producing a vane grille configuration for an exhaust gas turbocharger with a variable turbine geometry, which comprises the steps of:
providing at least one sheet metal part;
producing a carrier ring with recesses formed therein from the at least one sheet metal part;
providing VTG guide vanes; and
inserting the VTG guide vanes in the recesses of the carrier ring.

31. The method according to claim 30, which further comprises producing at least one of the sheet metal part forming the carrier ring and the recesses by a shearing method.

32. The method according to claim 31, which further comprises producing at least one of the sheet metal part forming the carrier ring and the recesses by at least one of a stamping method and a nibbling method.
